(19) United States
(12) Patent Application Publication
(10) Pub. No.: US 2016/0037912 A1
(43) Pub. Date: Feb. 11, 2016

(54) Pull-down cabinet with a piston resistance mechanism and a method for its use

(71) Applicant: Idea Potent, LLC, Walnut, CA (US)

(72) Inventor: Boban Jose, San Ramon, CA (US)

(21) Appl. No.: 14/456,318

(22) Filed: Aug. 11, 2014

(51) Int. Cl. A47B 51/00; E05F 3/02; A47B 46/00

(52) U.S. Cl. CPC A47B 51/00; A47B 46/005; E05F 3/02; A47B 2051/005

(57) ABSTRACT

A pull-down cabinet includes a first element fixed to an elevated structure, a second element having at least one storage surface, and at least one resistance mechanism comprising a tube having a substantially closed end, a piston within the tube creating a chamber between the piston and the substantially closed end, and a one-way valve communicating with the chamber such that the one-way valve opens, allowing fluid to pass through the one-way valve rapidly, when the piston is moved in a first direction within the tube, and closes, allowing substantially less fluid to pass through the one-way valve, when the piston is moved in a second direction within the tube, the resistance mechanism joining the first element to the second element so that when the second element slides away from the first element, the one-way valve closes, and when the second element slides toward the first element, the valve opens.

### TECHNICAL FIELD

The disclosed device relates generally to storage systems, and particularly to cabinetry.

### BACKGROUND ART

Finding sufficient space to store and organize household objects is a perennial challenge, particularly in urban environments. Installing shelving can help with organization, but generally at the expense of floor space. Shelves attached to walls higher up can leave more floor space, but are hard to reach. Past solutions to this issue have involved using stepladders or folding or sliding cabinets. The use of stepladders is unwieldy, and past pull-down cabinets have been heavy and inconvenient to use.

Therefore, there remains a need for a convenient pull-down cabinet for space-saving storage.

### SUMMARY OF THE EMBODIMENTS

In one aspect, a pull-down cabinet with a piston resistance mechanism includes a first element fixed to an elevated structure, a second element having at least one storage surface, and at least one resistance mechanism including a tube having a substantially closed end, a piston within the tube creating a chamber between the piston and the substantially closed end, and a one-way valve communicating with the chamber such that the one-way valve opens, allowing fluid to pass through the one-way valve rapidly, when the piston is moved in a first direction within the tube, and closes, allowing substantially less fluid to pass through the one-way valve, when the piston is moved in a second direction within the tube, the resistance mechanism joining the first element to the second element so that when the second element slides away from the first element, the one-way valve closes, and when the second element slides toward the first element, the one-way valve opens.

In a related embodiment, the first element further includes a housing into which the second element slides when pushed upward. In another related embodiment, the one-way valve includes a washer that seals the piston against the side of the tube, a first support element that supports the washer against the side of the tube when the piston is being pulled in one direction, and a second support element that allows part of the washer to be forced away from the side of the tube by fluid pressure when the piston is being pushed in the opposite direction. In another related embodiment, the one-way valve includes a check valve. In an additional embodiment, the resistance mechanism further includes a bleed valve, communicating with the chamber, that allows a limited flow of fluid though the bleed valve. In another embodiment, the bleed valve may be adjusted to modify the rate of fluid flow permitted by the bleed valve. In another embodiment still, the fluid is a liquid. In yet another embodiment, the fluid is a gas. In an additional embodiment, the tube further includes at least one cross-sectional irregularity in the interior surface of the tube, the at least one cross-sectional irregularity allowing gas to pass around the piston when the piston passes over the at least one cross-sectional irregularity. In another embodiment, the at least one cross-sectional irregularity includes at least one groove.

An additional embodiment includes a latch that immobilizes the first element and second element relative to each other when the latch is engaged. In one embodiment, the latch further includes a cam follower element rotably attached to one element of the first element and second element, the cam follower element having an exterior surface and a cam follower mounted on the exterior surface, and a cam arrangement fixed to the other element of the first element and second element, and positioned so that the cam follower element is inserted within the cam arrangement when the first element and second element are together, the cam arrangement including a plurality of catch elements separated by grooves, each catch element having a cam surface that guides the cam follower into a groove when the cam follower element is inserted into the cam arrangement and a notch that admits the cam follower, such that when the cam follower rests in the notch the first element and second element are latched together, and a plurality of wedge cams positioned to guide the cam follower into the notch of one of the plurality of catch elements when the cam follower passes through one of the grooves prior to contacting the wedge cams, and to guide the cam follower into a groove when the cam follower exits a notch prior to contacting the wedge cams. Some embodiments further include at least one slide track coupling the first element to the second element.

In another aspect, a pull-down cabinet includes a first element fixed to an elevated structure, a second element slidably attached to the first element such that the second element may be pulled downward from the first element, the second element having at least one storage surface, and a latching mechanism, including a cam follower element rotably attached to one element of the first element and second element, the cam follower element having an exterior surface and a cam follower mounted on the exterior surface, and a cam arrangement fixed to the other element of the first element and second element, and positioned so that the cam follower element is inserted within the cam arrangement when the first element and second element are together, the cam arrangement including a plurality of catch elements separated by grooves, each catch element having a cam surface that guides the cam follower into a groove when the cam follower element is inserted into the cam arrangement and a notch that admits the cam follower, such that when the cam follower rests in the notch the first element and second element are latched together, and a plurality of wedge cams positioned to guide the cam follower into the notch of one of the plurality of catch elements when the cam follower passes through one of the grooves prior to contacting the wedge cams, and to guide the cam follower into a groove when the cam follower exits a notch prior to contacting the wedge cams.

In a related embodiment, the first element further includes a housing into which the second element slides when pushed upward. Another embodiment further includes at least one resistance mechanism that resists the motion of the second element when it slides away from the first element. An additional embodiment includes a return mechanism that pulls the second element up to the first element.

In another aspect, a method for using a pull-down cabinet with a piston resistance mechanism includes providing a pull-down cabinet as described above, causing the second element to descend from the first element, placing an item on the at least one storage surface, and causing the second element to ascend to the first element.

Other aspects, embodiments and features of the device will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the device shown where illustration is not necessary to allow those of ordinary skill in the art to understand the device.

### BRIEF DESCRIPTION OF THE DRAWINGS

The preceding summary, as well as the following detailed description of the disclosed device, will be better understood when read in conjunction with the attached drawings. It should be understood that the device is not limited to the precise arrangements and instrumentalities shown.

FIG. 1A is a schematic diagram depicting one embodiment of the disclosed pull-down cabinet;

FIG. 1B is a schematic diagram depicting a partial cut-away of one embodiment of the disclosed pull-down cabinet;

FIG. 1C is a schematic diagram depicting one embodiment of the disclosed pull-down cabinet;

FIG. 2A is a schematic diagram depicting an embodiment of a piston resistance mechanism;

FIG. 2B is a schematic diagram depicting an embodiment of a one-way valve;

FIG. 2C is a schematic diagram depicting an embodiment of a piston resistance mechanism;

FIG. 3A is a schematic diagram depicting an embodiment of a surface bearing a cam follower;

FIG. 3B is a schematic diagram of one half of a cam arrangement;

FIG. 3C is a schematic diagram of the other half of the cam arrangement depicted in FIG. 3B;

FIG. 3D is a schematic diagram showing a portion of the assembled cam arrangement and the path a cam follower follows through the arrangement; and

FIG. 4 is a flow diagram depicting a method for using a pull-down cabinet as described herein.

### DETAILED DESCRIPTION OF SPECIFIC EMBODIMENTS

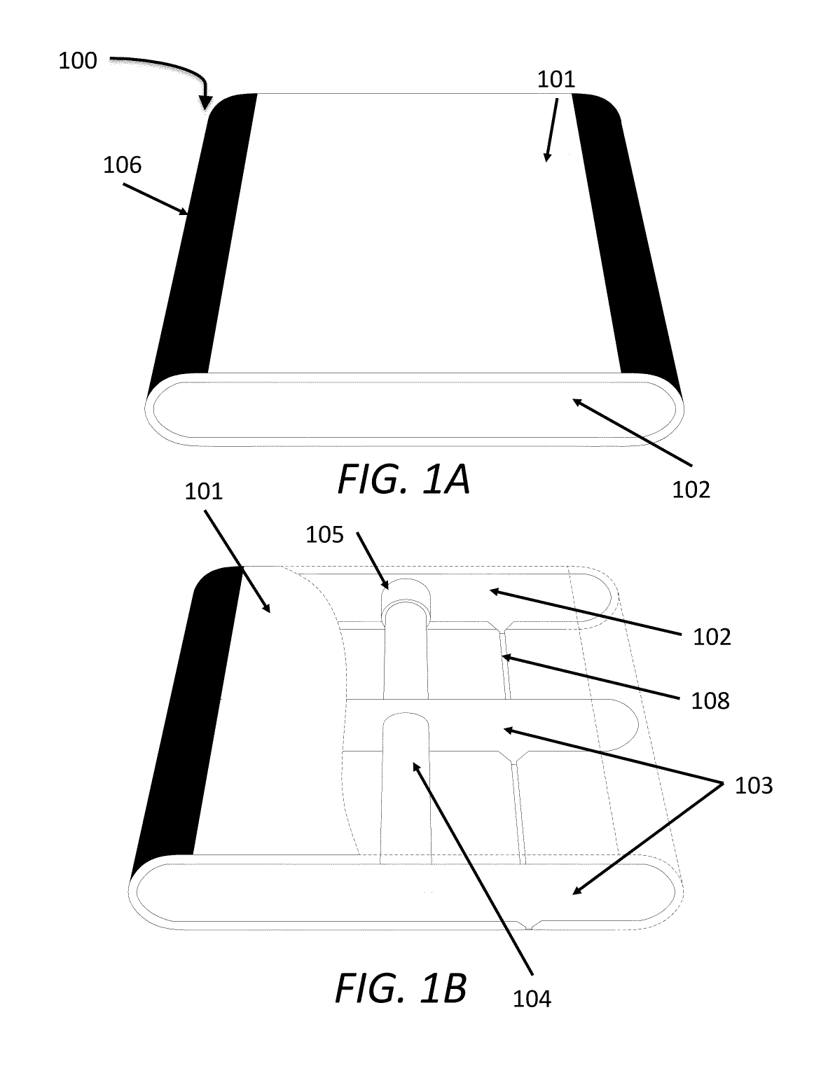

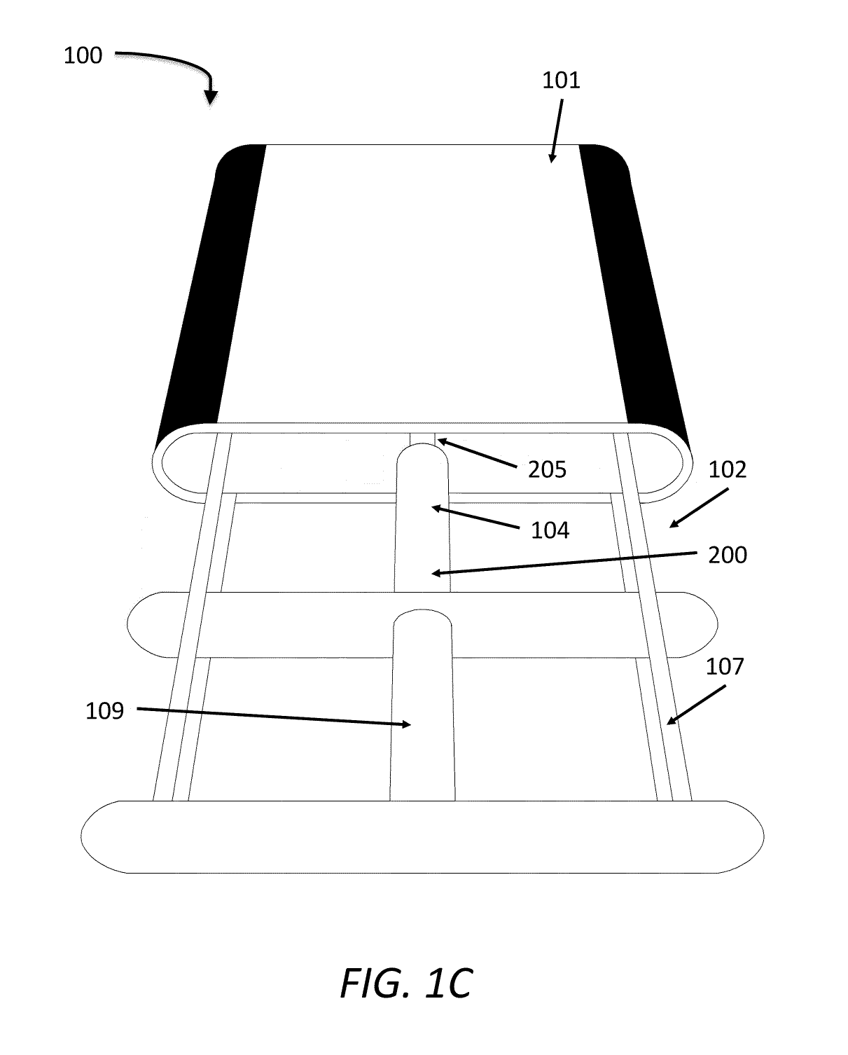

FIGS. 1A-1C illustrate some embodiments of a pull-down cabinet 100. As a brief overview, the pull-down cabinet 100 includes a first element 101 fixed to an elevated structure. The pull-down cabinet 100 includes a second element 102 having at least one storage surface 103. In some embodiments, the pull-down cabinet 100 has at least one resistance mechanism 104 joining the first element 101 to the second element 102 in such a way as to resist the motion of the second element 102 when the second element 102 slides away from the first element 101. In some embodiments, the pull-down cabinet 100 includes a latch 105 that immobilizes the first element 101 and second element 102 relative to each other when engaged.

Referring to FIGS. 1A-C in more detail, the pull-down cabinet 100 includes a first element 101 fixed to an elevated structure. The first element 101 may be constructed of any material or combination of materials of sufficient strength and rigidity to support the weight of the remainder of the structure and to withstand the additional stress imposed by the movement of the second element and a resistance mechanism if used, as described in further detail below. The first element 101 may be composed at least in part of a polymer; the polymer may be a plastic. The polymer may be a resin. The first element 101 may be composed at least in part of a metal, such as steel, aluminum or titanium. The first element 101 may be composed at least in part of wood. The first element 101 may be composed at least in part of a composite material such as fiberglass. The first element 101 may be composed at least in part of glass. The first element 101 may be composed at least in part of a textile, such as canvas.

The first element 101 is fixed to an elevated structure. In an embodiment, an elevated structure is a structure sufficiently elevated to permit the second element 102 to be slid far enough down from first element 101 to give the user full access to the at least one storage surface 103. The elevated structure may be a wall. The elevated structure may be a ceiling. The elevated structure may be a door. The elevated structure may be a pillar, such as an anti-seismic pillar in an office or dwelling. The elevated structure may be a pole. The elevated structure may be a fixture, such as another cabinet; for instance, the first element 101 may be fixed to the side of an elevated set of kitchen cabinets. The elevated structure may be another item of furniture, such as a bookcase or desk. The first element 101 may be attached to the elevated structure by any device suitable for fixing one rigid object to another; the first element 101 may be nailed to the elevated structure. The first element 101 may be bolted to the elevated structure. The first element 101 may be screwed to the elevated structure. The first element 101 may be adhered to the elevated structure.

In some embodiments, the first element 101 includes a housing into which the second element 102 slides when pushed upward. The housing may enclose substantially all of the second element 102. The housing may enclose enough of the second element 102 to conceal all of the at least one storage surface 103. In some embodiments, the housing includes one or more detachable panels 106. The one or more detachable panels 106 may be formed from any material or combination of materials suitable for the construction of the first element 101. The one or more detachable panels 106 may have one or more colors contrasting with another portion of the first element 101. The one or more detachable panels 106 may be interchangeable with other detachable panels 106; for instance, the user may be able to select detachable panels 106 from an assortment of detachable panels having various colors, so as to cause the detachable panels 106, and hence the pull-down cabinet 101 to match the user's desired decorative scheme. In other embodiments, the detachable panels 106 contain at least one light-producing element. The light-producing element may include an incandescent light bulb. The light-producing element may include a florescent light bulb, such as a compact florescent light. The light-producing element may include an electroluminescent device such as a light-emitting diode (LED). The light-producing element may be bioluminescent. The light-producing element may be phosphorescent; for instance, the one or more detachable panels 106 may contain phosphorescent dye. The light-producing element may be chemiluminescent. The light-producing element may be radioluminescent. The one or more detachable panels 106 may include a painting. The one or more detachable panels 106 may include a bamboo panel. Although in the embodiments depicted in FIGS. 1A-1C the one or more detachable panels 106 are located on the sides of the first element 101, the one or more detachable panels 106 may comprise any exterior surface of the first element 101, including its front or its top.

In some embodiments, the first element 101 and one or more detachable panels 106 are formed to accept an additional element between them. The additional element may have a display; for instance, the additional element may be a clock, television, computer monitor, tablet, or other electronic item that displays through a transparent detachable panel 106. The additional element may be a picture. The additional element may be a work of art.

The pull-down cabinet 100 includes a second element 102 having at least one storage surface 103. The second element 102 may be composed of any material or combination of materials suitable for constructing the first element 101. The at least one storage surface 103 may be one or more shelves. The at least one storage surface 103 may include one or more drawers. The at least one storage surface 103 may include any storage element used in cabinets. The at least one storage surface 103 may include one or more slanted holders, such as those commonly used for toothbrushes. In some embodiments, the second element 102 includes one or more braces 107 that hold together portions of the second element 102; the braces 107 may strengthen the second element 101. The braces 107 may make it easier to move the second element as a unit; for instance, the braces 107 may make the second element 102 more rigid. The braces 107 may help the second element 101 to slide smoothly against or within the first element 101. Some embodiments of the pull-down cabinet 101 include at least one slide track 108 coupling the first element to the second element. In one embodiment, a slide track 108 is a device such as a drawer glide or a groove and projection combination that constrains the second element 102 to slide along a certain path relative to the first element 101. As a further example the slide track 108 may also include a rod fixed to the first element 101 that passes through one or more holes in the second element 102, so that the second element 102 is constrained to slide up and down the rod. The rod may be fixed to the second element 102 and slide through at least one hole in the first element 101, alternatively.

In some embodiments, the pull-down cabinet 100 has at least one resistance mechanism 104 that resists the motion of the second element 102 when it slides away from the first element 101. In some embodiments, the resistance mechanism 104 includes a biasing means; the resistance mechanism 104 may include a spring. The spring may be a coil spring. The spring may be a leaf spring. The spring may be a gas spring made up of a piston sealed in a gas-filled tube, such that the elasticity of the gas causes the piston to exert a recoil force when pulled into or pushed out of the tube. The resistance mechanism 104 may include a weight; for instance, a cable attached to the second element 102 may pass over a pulley attached to the first element 101 and attach to a counterweight at the other end of the cable, such that pulling the second element 102 downward pulls the counterweight upward toward the pulley; as a result, the counterweight may exert a force resisting the downward motion of the second element 101.

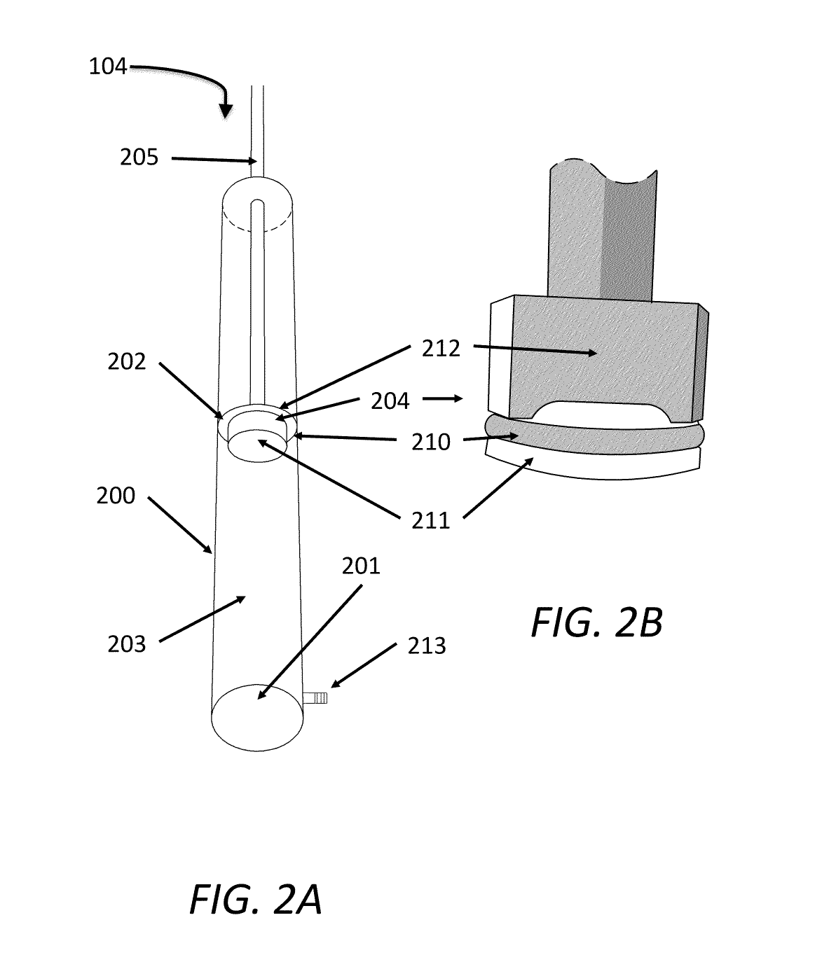

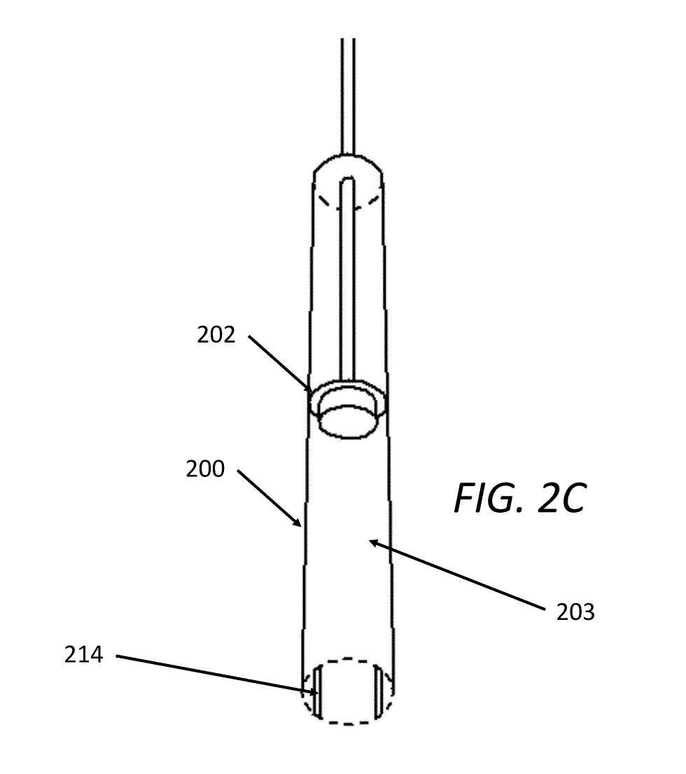

In other embodiments, as shown in FIG. 2A, the at least one resistance mechanism includes a tube 200 having a substantially closed end 201, a piston 202 within the tube creating a chamber 203 between the piston and the substantially closed end 201, and a one-way valve 204 communicating with the chamber 203 such that the one-way valve 204 opens, allowing fluid to pass through the one-way valve 204 rapidly, when the piston 202 is in moved in a first direction within the tube 200, and closes, allowing substantially less fluid to pass through the one-way valve 204, when the piston 202 is moved to in a second direction within the tube 200. In an embodiment, a valve is communicating with the chamber 203 if fluid flowing through the valve is flowing into or out of the chamber 203. This resistance mechanism may be attached to the first element 101 and the second element 102 so that when the second element 102 slides away from the first element 101, the one-way valve closes, and when the second element slides toward the first element, the one-way valve opens. In some embodiments, the tube 200 is attached to the first element 101, and the piston 202 is attached to the second element 102 by a rod 205 that extends from the tube 200. The substantially closed end 201 may be the end opposite where the rod 205 exits the tube 200 placing the chamber 203 between the piston 202 and that end 201, as depicted in FIG. 2A; the valve 204 may open when the chamber 203 contracts, allowing rapid flow of fluid out of the chamber 203, and close when the chamber 203 expands, allowing a much lower flow of fluid out of the chamber 203. Alternatively, the substantially closed end 201 may be at the end that the rod 205 exits from the tube 200, with a substantially fluid-tight seal around the rod 205 where it exits the tube, and placing the chamber 203 on the other side of the piston 202; in that case the one-way valve 205 may open when the chamber 203 expands, allowing rapid flow of air into the chamber, and close when the chamber 203 contracts, allowing much less rapid flow of air out of the chamber 203. In some embodiments, both ends of the tube 200 are sealed, creating a double chamber 203 divided by the piston, so that the one-way valve 204 is effectively controlling how rapidly fluid flows from one chamber 203 to the other chamber 203.

In other embodiments, the tube 200 is connected to the second element 102 and the piston rod 205 is connected to the first element 102, as depicted in FIG. 1C. The substantially closed end 201 may be the end opposite where the rod 205 exits the tube 200 placing the chamber 203 between the piston 202 and that end 201, as depicted in FIG. 2A; the one-way valve 205 may open when the chamber 203 contracts, allowing rapid flow of air out of the chamber, and close when the chamber 203 expands, allowing much less rapid flow of air into the chamber 203. Alternatively, the substantially closed end 201 may be at the end that the rod 205 exits from the tube 200, with a substantially fluid-tight seal around the rod 205 where it exits the tube, and placing the chamber 203 on the other side of the piston 202; in that case the valve 204 may open when the chamber 203 expands, allowing rapid flow of fluid into of the chamber 203, and close when the chamber 203 contracts, allowing a much lower flow of fluid out of the chamber 203.

In some embodiments, as shown in FIG. 2B, the one-way valve 204 includes a washer 210 that seals the piston 202 against the side of the tube 200, a first support element 211 that supports the washer 210 against the side of the tube 200 when the piston 202 is being pulled in one direction, and a second support element 212 that allows part of the washer 210 to be forced away from the side of the tube 200 by fluid pressure when the piston 202 is being moved in the opposite direction. The washer may be formed from a flexible material such as rubber, silicone, or an elastomer. For instance, in an embodiment where the one-way valve 204 is oriented to close when the piston 202 is moved to expand the chamber 203 and to open when the piston 202 is moved to contract the chamber 203, the first support element 211 is positioned on the side of the washer 210 inside the chamber 203, and the second support element 212 is positioned on the side of the washer 210 outside the chamber 203, so that the washer 210 bends around the second support element 212 to allow fluid to escape past the washer 210 when the piston 202 is moved to contract the chamber 203, as further illustrated by FIG. 2A.

In other embodiments, the one-way valve 204 is a check valve. The valve 204 may be a diaphragm check valve. The valve 204 may be a swing check valve. The valve 204 may be a tilting disc check valve. The valve 204 may be a lift-check valve. The valve 204 may be an in-line check valve. The valve 204 may be a duckbill valve. The valve 2054may be located at the substantially closed end 202 of the tube 200.

In some embodiments, the resistance mechanism 104 further includes a bleed valve 213, communicating with the chamber 203, that allows a limited flow of fluid though the bleed valve 213; this may result in some fluid being able to pass into or out of the chamber 203 even when the one-way valve 204 is closed. In some embodiments, the bleed valve 213 may be adjusted to modify the rate of fluid flow permitted by the bleed valve 213. For instance, the bleed valve 213 may be threaded so that rotation in one direction opens the bleed valve 213 further while rotation in another direction closes the bleed valve 213 to a greater extent; a user may thus be able to adjust the resistance of the resistance mechanism by rotating the bleed valve 213. The bleed valve 213 may be in the piston 202; for instance, the bleed valve 213 may be a small hole in the piston 202.

In some embodiments, the fluid used in the resistance mechanism 104 is a liquid. The liquid may enter and exit the chamber 203 via the one-way valve 204 and the bleed valve 213 through tubes connected to a tank containing the liquid. Alternatively, in a double-chambered embodiment, the tube may be sealed sufficiently at both ends to keep the fluid from leaking out. In other embodiments, the fluid is a gas. The fluid may be air, for instance, such as the ambient air where the pull-down cabinet 100 is located. In some embodiments, the tube includes at least one cross-sectional irregularity 214 in the interior surface of the tube 200, the at least one cross-sectional irregularity 214 allowing gas to pass around the piston 202 when the piston passes over the at least one cross-sectional irregularity. For instance, the tube 200 may be slightly elliptical for a portion of its length, allowing some air to leak around a circular piston 202. The at least one cross-sectional irregularity 214 may include at least one groove in the interior surface of the tube 200. The at least one cross-sectional irregularity 214 may run along a portion of the length of the tube 200. The at least one cross-sectional irregularity 214 may be located in a part of the tube 200 that the piston 202 passes through when the second element 102 begins to descend from the first element 101, so that initially the descent has very little resistance, and the resistance gradually builds up as the second element 102 descends further and the piston 202 moves into the part of the tube 200 that has no irregularity 214; this may have the effect of smoothly reducing the speed of descent of the second element 102 and preventing it ending its descent with a jerk.

The pull-down cabinet 100 may also include a return mechanism 109 that pulls the second element up to the first element. The return mechanism 109 may be a gas spring; in some embodiments, the gas spring is a piston 203 in a tube 200 as described above in relation to FIGS. 2A-2B, but without the one-way valve, so that the gas remains in the chamber 204. In other embodiments, the return mechanism 109 is the pulley, counterweight, and cable set described above in relation to FIGS. 1A-1C. The return mechanism may be a spring. The return mechanism 109 may be motorized; for instance, the return mechanism may be a pump or impeller that drives fluid into the chamber 203 described above in reference to FIG. 2A. The return mechanism 109 may be a cable and pulley as described above in reference to FIGS. 1A-C, with the cable attached to a motorized winch. The return mechanism may allow the user to pull the cable in the cable and pulley system described above in reference to FIGS. 1A-C; the user may be able to pull the cable directly, or to operate a crank-winch to pull on the cable.

In some embodiments, the cabinet 100 includes a power source (not shown). The power source may be hydraulic; for instance, the power source may be a line connected to the running water of the office or dwelling containing the cabinet 101, e.g. using water pressure to force water into the chamber 203 as described above for a return mechanism 109 in reference to FIGS. 1A-C. The power source may be pneumatic; for instance, the power source may be a line connected to an gas pressure source, e.g. using air pressure to force gas into the chamber 203 as described above for a return mechanism 109 in reference to FIGS. 1A-C. The power source may be any electrical power source. For instance, the power source may be a cable connecting the cabinet 100 to the electrical system of the office or dwelling containing the cabinet; the power source may be a wall plug. The power source may be a battery pack; in some embodiments, the battery pack is rechargeable. The power source may be photovoltaic, such as a cable connected to an exterior solar panel, or a solar panel mounted on the first element 101. The cabinet 100 may use the power source to power a motor driving the return mechanism 109 as described above in reference to FIGS. 1A-1C. The cabinet 100 may use the power source to power a display as described above in reference to FIGS. 1A-1C. The cabinet 100 may use the power source to power one or more charging ports (not shown). The one or more charging ports may be elements that charge electrical appliances; the one or more one or more charging ports may include an electrical outlet. The one or more one or more charging ports may include a universal serial bus (USB) port. The one or more one or more charging ports may include a device-specific port such as a port to charge a particular smartphone or tablet. The one or more one or more charging ports may include an inductive charging source.

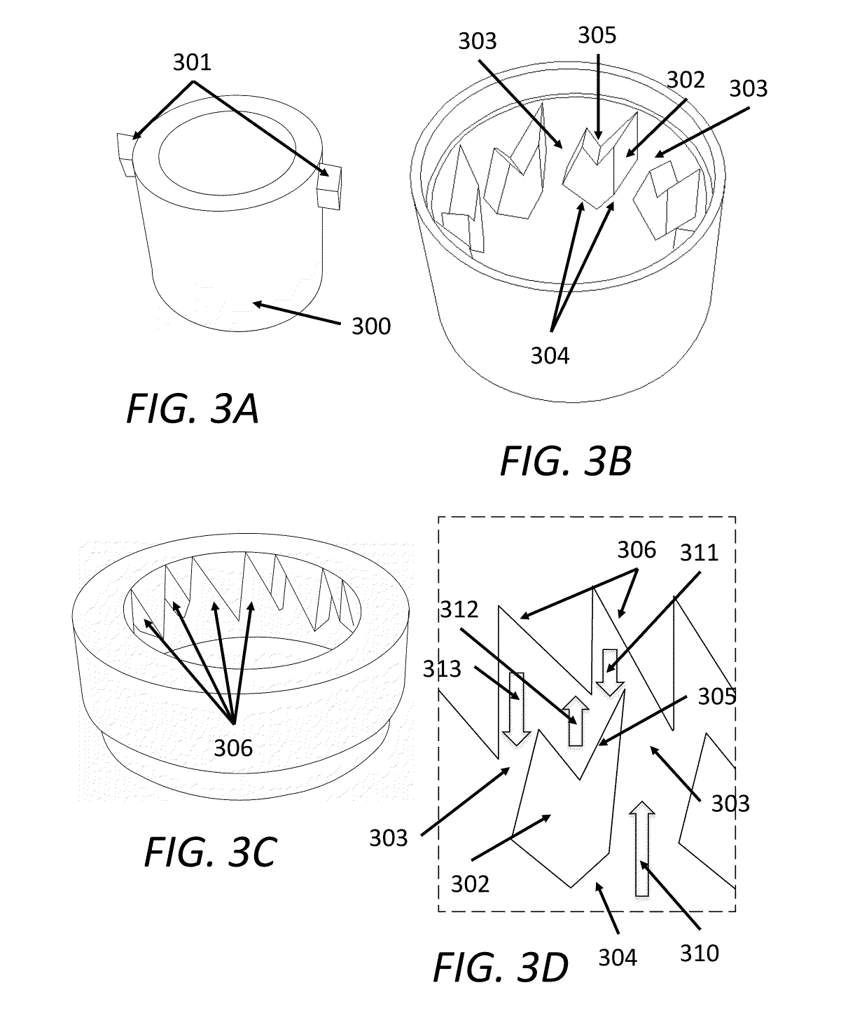

In some embodiments, the pull-down cabinet 100 includes a latch 105 that immobilizes the first element 101 and second element 102 relative to each other when the latch 105 is engaged. The latch 105 may engage the bottom of the first element 101 and the bottom of the second element 102 when the first element 101 and the second element 102 are together; for instance, where the first element 101 includes a housing that can contain the second element 102, the latch 105 may extend one or more catches from the edges of the housing to overlap the second element 102 when it is inserted, preventing the second element 102 from being pulled downward until the one or more catches are disengaged. FIGS. 3A-3D illustrate another embodiment of the latch 105. In some embodiments, the latch 105 includes a cam follower element 300 rotably attached to one element of the first element 101 and second element 102, the cam follower element 300 having an exterior surface and a cam follower 301 mounted on the exterior surface, and a cam arrangement fixed to the other element of the first element 101 and second element 102, and positioned so that the cam follower element 300 is inserted within the cam arrangement when the first and second element are together. In some embodiments, the cam follower element 300 is the tube 200. In other embodiments, the cam follower element 300 is attached to the tube 200. In some embodiments, the cam arrangement includes a plurality of catch elements 302 separated by grooves 303, each catch element 302 having a cam surface 304 that guides the at least one cam follower 301 into a groove when the cam follower element 300 is inserted into the cam arrangement and a notch 305 that admits the cam follower 301, such that when the cam follower 301 rests in the notch 305 the first element 101 and second element 102 are latched together, and a plurality of wedge cams 306 positioned to guide the cam follower 301 into the notch 305 of one of the plurality of catch elements 302 when the cam follower 301 passes through one of the grooves 303 prior to contacting the wedge cams 306, and to guide cam follower 301 into a groove 303 when cam follower 301 exits a notch 305 prior to contacting the wedge cams 306. Where the cam follower element 300 is attached to the second element 102, the cam arrangement may be attached to the first element 101; likewise, where the cam follower element 300 is attached to the first element, the cam arrangement may be attached to the second element 102. Persons skilled in the art will be aware that the latch will function in either position.

FIG. 3D depicts an exemplary embodiment of a portion of the cam assembly, and the path that the cam follower 301 may take through the cam assembly. In the example, when the second element 102 is pushed up to the first element 101, the cam follower element 300 enters the cam assembly, so that the cam follower 301 is guided by the cam surface 304 of one of the catch elements 302 into a groove 303, rotating the cam follower element 300 as necessary to allow the cam follower 301 to be guided (310). Continuing the example, as it travels up through the groove, the cam follower 301 contacts a wedge cam 306, which forces the cam follower to a position over a notch 305, occasioning a further rotation of the cam follower element 300. Further continuing the example, when the user releases the second element 102, the cam follower 301 falls back down into the notch 305, locking together the first element 101 and the second element 102 (311); the notch may also move the cam follower 301 sideways to position it for the next step. As the example continues, if the user wishes to lower the second element 101 again, the user pushes up on the second element 101, causing the cam follower 301 to travel upwards from the notch 305 (312). Continuing the example, the cam follower 301 contacts a wedge cam 306, forcing it to the side, and causing the cam follower element to rotate again 300, so that it is over a groove 303. Further continuing the example, when the user pulls down on the second element 102 or releases it to descend under its own weight, the cam follower 301 travels down through the groove 303, allowing the second element 102 to descend fully.

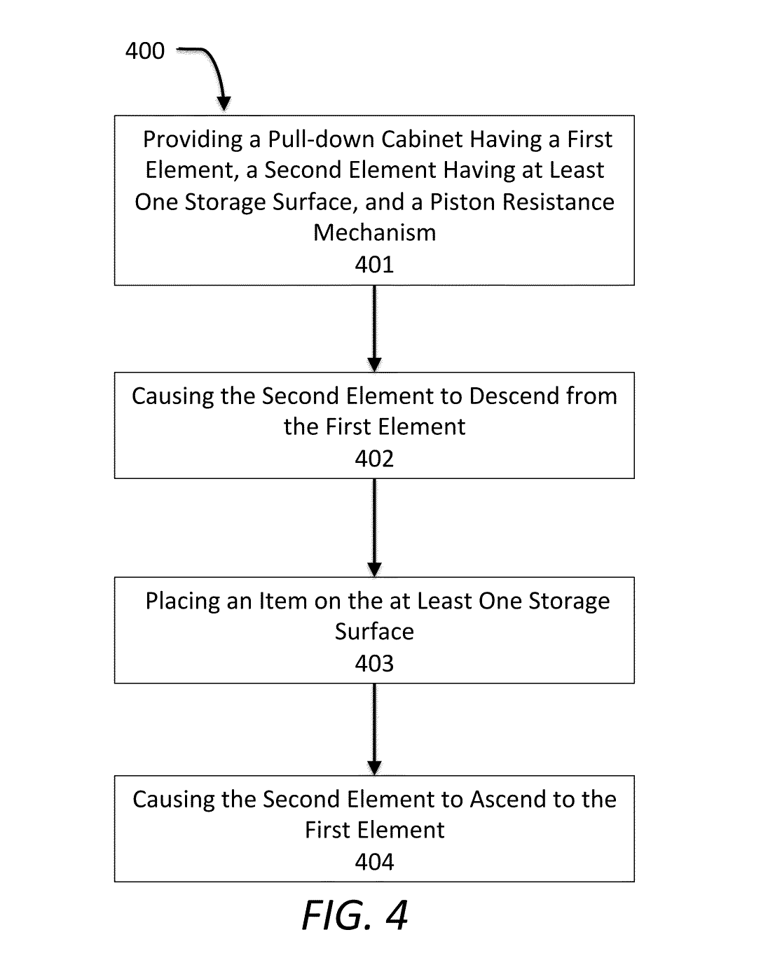

FIG. 4 illustrates some embodiments of a method 400 for using a pull-down cabinet with a piston resistance mechanism. The method 400 includes providing a pull-down cabinet with a resistance mechanism including a tube, piston, and one-way valve, as described above in reference to FIGS. 1A-3D (401). The method 400 includes causing the second element to descend from the first element (402); this may be implemented as described above in reference to FIGS. 1A-3D. The method 400 includes placing an item on the at least one storage surface (403); this may be implemented as described above in reference to FIGS. 1A-3D. The method 400 includes causing the second element to ascend to the first element (404); this may be implemented as described above in reference to FIGS. 1A-3D. Some embodiments of the method 400 further include adjusting a bleed valve 213 as described above in reference to FIG. 2A. Some embodiments of the method 400 further involve engaging a latch 105 as described above in reference to FIGS. 1A-C and 3A-D.

It will be understood that the device may be embodied in other specific forms without departing from the spirit or central characteristics thereof. The present examples and embodiments, therefore, are to be considered in all respects as illustrative and not restrictive, and the device is not to be limited to the details given herein.

What is claimed is:

1. A pull-down cabinet with a piston resistance mechanism, the cabinet comprising:
a first element fixed to an elevated structure;
a second element having at least one storage surface; and
at least one resistance mechanism comprising a tube comprising a substantially closed end, a piston within the tube creating a chamber between the piston and the substantially closed end, and a one-way valve communicating with the chamber such that the one-way valve opens, allowing fluid to pass through the one-way valve rapidly, when the piston is moved in a first direction within the tube, and closes, allowing substantially less fluid to pass through the one-way valve, when the piston is moved in a second direction within the tube, the resistance mechanism joining the first element to the second element so that when the second element slides away from the first element, the one-way valve closes, and when the second element slides toward the first element, the one-way valve opens.

2. A device according to claim 1, wherein the first element further comprises a housing into which the second element slides when pushed upward.

3. A device according to claim 1, wherein the one-way valve comprises:
a washer that seals the piston against the side of the tube;
a first support element that supports the washer against the side of the tube when the piston is being pulled in one direction; and
a second support element that allows part of the washer to be forced away from the side of the tube by fluid pressure when the piston is being pushed in the opposite direction.

4. A device according to claim 1, wherein the one-way valve comprises a check valve.

5. A device according to claim 1, wherein the resistance mechanism further comprises a bleed valve, communicating with the chamber, that allows a limited flow of fluid though the bleed valve.

6. A device according to claim 5, wherein the bleed valve may be adjusted to modify the rate of fluid flow permitted by the bleed valve.

7. A device according to claim 1, wherein the fluid is a liquid.

8. A device according to claim 1, wherein the fluid is a gas.

9. A device according to claim 1, wherein the tube further comprises at least one cross-sectional irregularity in the interior surface of the tube, the at least one cross-sectional irregularity allowing gas to pass around the piston when the piston passes over the at least one cross-sectional irregularity.

10. A device according to claim 9, wherein the at least one cross-sectional irregularity comprises at least one groove.

11. A device according to claim 1 further comprising a latch that immobilizes the first element and second element relative to each other when the latch is engaged.

12. A device according to claim 11, wherein the latch further comprises:
a cam follower element rotably attached to one element of the first element and second element, the cam follower element having an exterior surface and a cam follower mounted on the exterior surface; and
a cam arrangement fixed to the other element of the first element and second element, and positioned so that the cam follower element is inserted within the cam arrangement when the first element and second element are together, the cam arrangement comprising:
a plurality of catch elements separated by grooves, each catch element having a cam surface that guides the cam follower into a groove when the cam follower element is inserted into the cam arrangement and a notch that admits the cam follower, such that when the cam follower rests in the notch the first element and second element are latched together; and
a plurality of wedge cams positioned to guide the cam follower into the notch of one of the plurality of catch elements when the cam follower passes through one of the grooves prior to contacting the wedge cams, and to guide the cam follower into a groove when the cam follower exits a notch prior to contacting the wedge cams.

13. A pull-down cabinet according to claim 1, further comprising at least one slide track coupling the first element to the second element.

14. A pull-down cabinet, the cabinet comprising:
a first element fixed to an elevated structure;
a second element slidably attached to the first element such that the second element may be pulled downward from the first element, the second element having at least one storage surface; and
a latching mechanism, comprising:
a cam follower element rotably attached to one element of the first element and second element, the cam follower element having an exterior surface and a cam follower mounted on the exterior surface; and
a cam arrangement fixed to the other element of the first element and second element, and positioned so that the cam follower element is inserted within the cam arrangement when the first element and second element are together, the cam arrangement comprising:
a plurality of catch elements separated by grooves, each catch element having a cam surface that guides the cam follower into a groove when the cam follower element is inserted into the cam arrangement and a notch that admits the cam follower, such that when the cam follower rests in the notch the first element and second element are latched together; and
a plurality of wedge cams positioned to guide the cam follower into the notch of one of the plurality of catch elements when the cam follower passes through one of the grooves prior to contacting the wedge cams, and to guide the cam follower into a groove when the cam follower exits a notch prior to contacting the wedge cams.

15. A pull-down cabinet according to claim 14, wherein the first element further comprises a housing into which the second element slides when pushed upward.

16. A pull-down cabinet according to claim 14 further comprising at least one resistance mechanism that resists the motion of the second element when it slides away from the first element.

17. A pull-down cabinet according to claim 14 further comprising a return mechanism that pulls the second element up to the first element.

18. A method for using a pull-down cabinet with a piston resistance mechanism, the method comprising:
providing a pull-down cabinet according to claim 1;
causing the second element to descend from the first element;
placing an item on the at least one storage surface; and
causing the second element to ascend to the first element.
